(19) United States
(12) Patent Application Publication
(10) Pub. No.: US 2004/0130055 A1
(43) Pub. Date: Jul. 8, 2004

(54) Method for fabricating siliconized silicon carbide parts

(76) Inventors: Joseph J. Beaman, Austin, TX (US); David L. Bourell, Austin, TX (US); Hong-yun Wang, Austin, TX (US); Seok-Min Park, Plano, TX (US)

Correspondence Address: Schwegman Lundberg, Woessner & Kluth, PO Box 2938, Minneapolis, MN, 55402, US

(21) Appl. No.: 10/432,689

(22) PCT Filed: Nov. 27, 2001
(86) PCT No.: PCT/US01/44425

(51) Int. Cl. B29C 35/08; B29C 41/02; B29C 37/02

(52) U.S. Cl. 264/161; 264/497; 264/233

(57) ABSTRACT

The present invention includes a method for fabricating Si/SiC parts for use in the microelectronics manufacturing industry. The method includes providing a SiC powder. The method also includes providing a polymer binder and mixing the SiC powder and the polymer binder to form a part using an SLS process.

### BACKGROUND OF INVENTION

The present invention relates to a method and to a system for fabricating Silicon/Silicon carbide (Si/SiC) parts for use in the microelectronics manufacturing industry. In particular, the method and system of the present invention use selective laser sintering, SLS, and post sintering silicon infiltration procedures to make parts of predetermined complexity without use of molds.

An existing commercial process for fabricating Si/SiC parts for use in the microelectronics manufacturing industry uses a slip that is cast into a mold. The term “slip” as used herein refers to SiC that is mixed with water and organic agents. The use of a mold in this commercial process requires an additional and costly manufacturing step. The mold must be manufactured using precision cutting, machining and polishing tools. The costly fabrication of the mold and lengthy time line required to fabricate the mold renders the existing commercial process costly and time-consuming.

A significant portion of a product design cycle in microelectronics manufacturing is taken up by building and testing prototype parts. Mold-making and molding steps have traditionally been employed in building prototype parts. Once the molds have been fabricated and the parts have been made using the molds, the parts have been tested. In order to speed up these building and testing processes, manufactures have sought new methods to enable rapid manufacturing of complex parts directly from computer-aided-design (CAD) data bases. In particular, additive processes for building up the parts from a material have been employed.

One additive process is referred to as selective laser sintering (SLS). One use of selective laser sintering is described in U.S. Pat. No. 5,284,695, which issued Feb. 8, 1994. According to the selective laser sintering process, a laser is scanned in raster fashion over a layer of fusible powder to fuse selected portions of the powder layer according to a cross-section of the desired part. After fusing the desired portions of a layer, another layer of powder is placed and is similarly selectively fused, with fused portions of the later layer fusing to the fused portions of the previous layer. Continued layer-wise processing in this manner results in a part which can be quite complex in the three-dimensional sense. Selective laser sintering methodologies are further described in U.S. Pat. Nos. 5,076,869; 4,944,817; 4,863,538; 5,017,753; and 4,938,816; 5,156,697; 5,147,587 and 5,182,170.

### SUMMARY OF INVENTION

One embodiment of the present invention includes a method for fabricating silicon/silicon carbide (Si/SiC) parts for use in the microelectronics manufacturing industry. The method comprises providing a silicon carbide (SiC) powder, providing a polymer binder and mixing the SiC powder with the binder to form a part using a selective laser sintering process. The part is usable in the microelectronics manufacturing industry.

Another embodiment of the present invention includes a system for rapid product modification, re-design, or manufacture, comprising a mixing device for mixing silicon carbide powder and polymer binder to form a suspension effective for introduction into a selective laser sintering device. The system also includes a selective laser sintering device that forms a part comprising sintered silicon carbide-polymer. The system also includes a device for siliconizing the part; a device for cleaning the siliconized part; a device for performing binder burnout on the part and a device for acid etching the part.

One other embodiment of the present invention includes a method for fabricating silicon/silicon carbide parts. The method includes providing a silicon carbide powder having particles within a size range of 15 to 100 micrometers. The method also includes providing a polymer binder and mixing the silicon carbide powder and polymer binder to form a mixture. The mixture is treated in a selective laser sintering process to form a part. The sintered part is infiltrated with silicon to form a silicon/silicon carbide part.

In a product aspect, the present invention includes parts manufactured by the methods and system of the present invention.

### BRIEF DESCRIPTION OF DRAWINGS

FIG. 1 is a schematic side view of a step of mixing binder with SiC.

FIG. 2 is a schematic side view of a step of an SLS process.

FIG. 3 is a schematic side view of a cleaning step.

FIG. 4 is a side view of a siliconization step.

FIG. 5 is a side view of a cool down step.

FIG. 6 is a side view of a cleaning/deburring/machining step.

FIG. 7 is a side view of a purification step.

FIG. 8 is a side view of a binder burnout step.

FIG. 9 is a side view of an acid etching step.

FIG. 10 is a side view of an optional CVD coating step.

### DETAILED DESCRIPTION

One embodiment of the present invention includes a method for fabricating Si/SiC parts for use in the microelectronics manufacturing industry. The method of the present invention is typically performed without a mold and therefore does not require a mold fabrication processing and mold fabrication equipment. Instead, the method of the present invention combines the power of selective laser sintering and post-processing steps, such as silicon infiltration, to create a process for rapidly making Si/SiC parts directly from a CAD database.

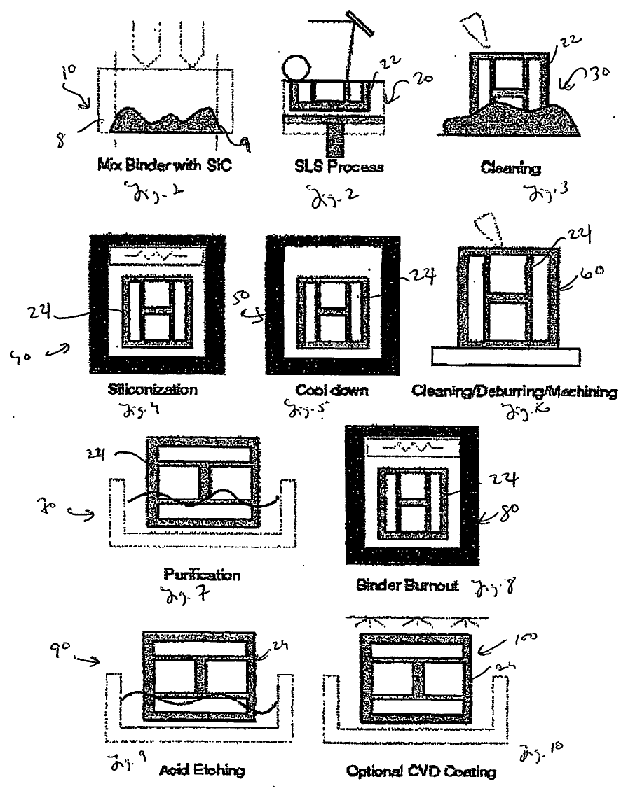

The fabrication method of the present invention comprises the processes of mixing a binder 8 with silicon carbide (SiC) 9 as shown at 10 in FIG. 1, to form a SiC-binder mixture and subjecting the SiC mixture to an SLS process as shown at 20 in FIG. 2, to form a sintered SiC part 22. The sintered SiC part 22 is cleaned as shown at 30 in FIG. 3, subjected to siliconization as shown at 40 in FIG. 4 and cool down as shown at 50 in FIG. 5. Siliconization forms a silicon/silicon carbide (Si/SiC) part 24. The cooled down sintered Si/SiC part 24 is subjected to cleaning, deburring and machining as shown at 60 in FIG. 6 and purification as shown at 70 in FIG. 7 to make a purified Si/SiC part 24. The purified Si/SiC part 24 is subjected to binder burnout as shown at 80 in FIG. 8 and acid etching as shown at 90 in FIG. 9. The Si/SiC part is optionally treated with a CVD coating.

As discussed, the process of the present invention eliminates the need for a mold. As a consequence, the process eliminates the time and space needed for slip draining and slip drying.

It has surprisingly been found that the process of the present invention permits use of coarse SiC particles, i.e., particle size ranges from 15 to 100 micrometers in fabrication of the part 22 and 24. Use of these larger silicon carbide particles eliminates a need for fine SiC powder and a need for pre-sintering and sintering aids. The larger particle sizes are usable, in part, because the binder has a viscosity and surface tension that adheres the larger particles to the binder and to each other during and after the sintering process. After sintering forms a sintered part structure, a green part, the exposed surface of the particles is siliconized. The siliconization of the part further strengthens the part and permits the use of coarse SiC particles in the pre-sintering mixture.

Pre-processed spherical SiC powder is usable in the method of the present invention but is not required for green body strength improvement observed in the process. It is believed that the post SLS processes, such as the siliconization process, employed in the method of the present invention, permit a use of the coarse particles and particles which are not uniformly spherical. It is believed that the siliconization substantially cements the particles.

With the process of the present invention, SiC powder is mixed with polymer binder to make a preform part using an SLS process. The binders are chosen from a class of polymers that create a retaining structure after burnout. Phenolic and nylon polymer binders are two examples of acceptable binders. In one embodiment, the binder is mixed with SiC powder by way of a spray drying process. The SiC powder is mixed with a polymer to form a slurry. The particles, having a size ranging from about 15 to 100 micrometers prior to coating, are mixed with a phenolic polymer binder or a nylon binder. Water or other solvent is added as needed to create a slurry. A thickening agent is also optionally added, in some instances, to prevent settling of the slurry and to provide for a desired viscosity for the sintering process.

In some embodiments, the slurry is presented to a conventional spray drying process to create a particle that is at least partially coated with binder to a size ranging from about 50 micrometers to a size that is greater than about 100 micrometers. While spray drying is described for use in the method and system of the present invention, it is believed that other mixing processes that produce at least partially coated particles that can be handled by SLS are suitable for use. The at least partially coated particles comprise the SiC powder and polymeric binder. The at least partially coated particles are of a size that can be handled in conventional selective laser sintering equipment.

As a result of the mixing process, the SiC powder is agglomerated with the polymer binder to form particles having a diameter, in some instances, greater than two to three times that of the original SiC powder. Physically, each particle of the coated powder will generally include multiple individual silicon carbide particles, coated together by the polymeric binder. The agglomeration of the particles provides particle sizes suitable for selective laser sintering, particularly in the dispensation of the powder in a smooth and uniform layer over the laser target surface. The agglomeration of the particles creates a sintered, retaining structure after burnout.

One laser sintering device suitable for use in the methods and system of the present invention is the SLS Model 125 and SLS Sinterstation 2000, manufactured and sold by DTM Corp. or Austin Tex. Other laser sintering devices are believed to be suitable for use in the method and system of the present invention.

The sintering is performed by selecting operating parameters, such as laser power and scan rate that are selected and optimized by one skilled in the art. Adjustment of operating parameters is generally required in the production of parts from specific materials. The laser power, and therefore the fusing temperature of the SLS process is selected to cause the polymer coating of the powder particles to sinter, that is, to flow and bind, at the selected locations of the layer fabricated. The temperature at which the polymer coating flows can be much lower than that at which the silicon carbide sinters. As such, particles of the high temperature powder constituent are unaffected by the selective laser sintering process, instead bound by the lower temperature polymer coating into the part cross-sections defined by the laser scanning. The laser scanning pattern is driven directly by the CAD data base used in designing the part.

The SLS process 20 produces a green part. The green part has the desired part shape and dimensions of a desired microelectronics part or part component. The green part has a structure that is needed to provide green body strength before silicon infiltration. The structure is not required to react with Si to form SiC. The green part is cleaned in a cleaning process 30.

In some embodiments, the green silicon carbide part is cleanable in an acid bath. The process of the present invention utilizes binders that are inert to weak acids and that are only slightly attacked by strong acids. The binders are also resistant to water, low temperature heat, and most solvents. Because of these binder properties, the acid cleaning process removes unfused powder but does not remove substantial quantities of binder.

The acid cleaned green silicon carbide part is subjected to a siliconization process 40 to permeate and bind the silicon carbide exposed surfaces to each other. In one embodiment, an aqueous colloidal silicate suspension is used, such as is manufactured by Aremco Products, Inc., of Ossining, N.Y. While the Aremco product is described, it is believed that other silicon suspensions and formulations are usable in the method and system of the present invention.

The silicon is applied in a manner that saturates the green part. The application mechanisms include but are not limited to soaking or spraying. In one embodiment, the silicon is applied and is then dried and cured. Successful silicon infiltration requires a nitrogen atmosphere and an enclosure to maintain controllable conditions for siliconization. The partial pressure of Silicon and nitrogen are carefully controlled in order to create an environment favorable to silicon infiltration. One method of control is the use of enclosures around the part during Si furnace infiltration.

Once silicon infiltration is performed on the part, the part is, for some embodiments, cured. The curing is performed, in some embodiments, at a temperature of about 100 degrees Centigrade and at a pressure that is not greater than atmospheric pressure. The silicon infiltration is accomplished at temperatures lower than conventional cementing process temperatures. The curing step is performed at a temperature that allows the polymer binder coating to continue to provide strength and dimensional accuracy to the siliconized part. After completion of the siliconization step and, optionally, a curing step, the silicon sufficiently binds the exposed silicon carbide surfaces, forming Si/SiC surfaces, to provide strength and dimensional accuracy to the part.

Once the part is treated and optionally cured in the siliconization process 40, the part is cooled down 50 and is subjected to cleaning, deburring and machining. The cleaning, deburring and machining of the part is performed using equipment and skill known to those skilled in the art. Because of the strength of the part, the part is machinable to form complex features. The part is subjected to a purification 70. The purification processes are performed using techniques known to those skilled in the art.

After cleaning, binder burnout 80 is carried out in a non-oxidizing atmosphere in order to create a sufficient retaining structure within the part. Nitrogen atmosphere is one example of the non-oxidizing atmosphere. The burnout is performed, in one embodiment, by slow heating to limit the possibility of fracturing of the part. Fracturing can occur when the polymer binder does not have time to exit the mixture. The heating can occur in an oven of simple design, such as a muffle furnace. Upon completion of the binder burnout 80, the part includes the silicon carbide, bound by the silicon cementing agent, to form Si/SiC.

For some embodiments, the part is too porous after treatment by a first siliconization process. Additional strength and density is imparted to the part by treating the part with a second siliconization process, after the binder burnout. The second siliconization process fills in voids left behind by the removal of the polymer binder. For some embodiments, another material is used to impart the strength and density, other than silicon.

The part is, in some embodiments, acid etched after binder burnout. Etching is performed in a manner that prepares the part for particular applications. For some embodiments, the part is CVD coated.

The method of the present invention permits complex shape design, a short turnaround cycle, a low temperature infiltration process, pressureless infiltration, a short production cycle, a rapid product modification, re-design and manufacture. In one embodiment, the method of the present invention is used to fabricate Si/SiC wafer holders and other components associated with microchip manufacture.

The method is also conducive to controllability with a wide operating range, such as the shape and size of the SiC powder, polymer binder, infiltrant-Si morphology, atmosphere control and infiltration temperature.

While the invention has been described herein relative to its preferred embodiments, it is of course contemplated that modifications of, and alternatives to, obtaining the advantages and benefits of this invention, will be apparent to those of ordinary skill in the art having reference to this specification and its drawings. It is contemplated that such modifications and alternatives are within the scope of this invention as subsequently claimed herein.

In the claims:

1. A method for fabricating silicon carbide parts for use in the microelectronics manufacturing industry, comprising:
providing a silicon carbide powder;
providing a polymer binder;
mixing the silicon carbide powder and the polymer binder to form a mixture; and
treating the mixture using a selective laser sintering process to form a part, wherein the part is usable in the microelectronics manufacturing industry.

2. The method of claim 1 wherein the fabrication of silicon carbide parts is performed without use of a mold.

3. The process of claim 2 wherein the fabrication eliminates time and space for slip draining and slip drying.

4. The process of claim 1 wherein the fabrication is performed without sintering or pre-sintering aids.

5. The process of claim 1 wherein the silicon carbide powder comprises particles within a size range of 15 to 100 micrometers.

6. The process of claim 1 and further comprising cleaning the sintered part.

7. The process of claim 6 wherein the sintered part is cleaned in an acid bath.

8. The process of claim 1 and further comprising infiltrating the sintered part with silicon to form silicon/silicon carbide.

9. The process of claim 8 wherein silicon infiltration is performed in a nitrogen atmosphere wherein the nitrogen and silicon have partial pressures effective to maximize infiltration.

10. The method of claim 8 and further comprising cooling down the part after infiltration with silicon.

11. The method of claim 8 and further comprising performing one or more of cleaning, deburring and machining.

12. The method of claim 8 and further comprising purifying the part that has been infiltrated with silicon.

13. The method of claim 9 and further comprising burning out the polymer binder.

14. The method of claim 13 wherein the polymer binder burnout is performed in a non-oxidizing atmosphere.

15. A part made by the process of claim 1.

16. A part made by the process of claim 14.

17. A system for rapid product modification, re-design, or manufacture, comprising:
a mixing device for mixing silicon carbide powder and polymer binder to form a suspension effective for introduction into an SLS;
an SLS forming a part comprising sintered silicon carbide-polymer particle;
a device for siliconizing the part;
a device for cleaning the siliconized part;
a device for performing binder burnout on the part; and
a device for acid etching the part.

18. A method for fabricating silicon/silicon carbide parts, comprising:
providing a silicon carbide powder having particles within a size range of 15 to 100 micrometers;
providing a polymer binder;
mixing the silicon carbide powder and the polymer binder to form a mixture;
treating the mixture in a selective laser sintering process to form a part; and
infiltrating the sintered part with silicon to form a silicon/silicon carbide part.

19. The method of claim 18 and further comprising treating the silicon/silicon carbide part to burn out the polymer binder.

20. The product produced by the method of claim 18.
